(19) United States
(12) Patent Application Publication
(10) Pub. No.: US 2005/0059303 A1
(43) Pub. Date: Mar. 17, 2005

(54) Dual plane power contact

(76) Inventors: Augusto P. Panella, Naperville, IL (US); Jeng-De Lin, Naperville, IL (US)

Correspondence Address: MOLEX INCORPORATED, 2222 WELLINGTON COURT, LISLE, IL, 60532, US

(21) Appl. No.: 10/928,355

(22) Filed: Aug. 27, 2004

Related U.S. Application Data
(60) Provisional application No. 60/498,078, filed on Aug. 27, 2003.

(51) Int. Cl. H01R 4/48

(52) U.S. Cl. 439/862

(57) ABSTRACT

A power contact is provided by utilizing a box-type structure formed form the mating together of two interengaging U-shaped channels. The channels have a web and two flanges extending from the web, in a spaced-apart fashion, to define a hollow, intervening space that extends lengthwise through the channel. A contact arm may be formed in the webs of the two channels, and the contact arms extend inwardly from their respective webs into the hollow, intervening space. The contact arms engage each other when the channels are engaged together in a fashion so that the webs are on opposing surfaces of the contact.

### BACKGROUND OF THE INVENTION

The present invention is directed generally to conductive power contacts used in electronic applications, and more particularly, to low inductance and low resistance contacts for use in quickly transferring power between circuits on two circuit boards.

The power demands made on computer processors increases with the development of newer and faster peripheral devices and circuits. Semiconductor devices, and particularly, computer processors now require more power than did their predecessors. Processor manufacturers, ASIC manufacturers and mother board designers are all interested in new ways to increase the power conveyed to the processor or semiconductor device without taking up a large amount of space on the mother board, meaning that they are reluctant to increase the size of the contacts that connect circuits on a motherboards to an integrated circuit or a daughter board. When the size of the contacts is increased, the contacts take up more room than is desired on the motherboard.

For designs that require high power, it is important to keep resistance of the contacts low. Keeping the resistance low also lowers the self-inductance of the power contact. However, another design aspect which is known as “mutual inductance” is an important design factor. Mutual inductance imparts loop inductance to contacts and this loop inductance may not be directly related to the resistance of the contact. Self and mutual inductance are directly related to loop inductance as expressed by the formula:
L_{LOOP}=Self Inductance_{POWER PATH}+Self Inductance_{RETURN PATH}−(2×Mutual Inductance between power and return path).

It is also desirable to provide high power delivery systems with low impedance over a large frequency range. As a side benefit of increasing mutual inductance, capacitive coupling is typically increased. As a general rule, the impedance of an interconnect can be represented by:
Z=(L_{LOOP}/Capacitance)

Contacts that utilize only a single contact arm, have only a single path cannot supply the desired level of inductance. The use of a single contact arm, may result in a contact force that may be less than desirable. In almost all cases, the current source and sink points must be offset from one another. As terminals must be soldered to one of the two circuit boards (either the motherboard or a secondary board), this also requires a single deflection force.

Typical known power contacts utilize either single spring arms, or a unitary base having a plurality of discrete spring arms extending therefrom. The base is usually soldered to a circuit board and the spring arms are bent upon themselves on their base so that the middle of the spring arm defines a contact surface that is approximately parallel with the base when the two circuit boards are pressed together to establish an electrical connection therebetween.

The present invention is directed to a power contact that overcomes the aforementioned disadvantages.

### SUMMARY OF THE INVENTION

The contact design philosophy can be used with interposer or soldered down type interconnects. The design can accommodate one piece or two-piece designs. Our design contemplates the use of a box contact in order to obtain lower loop inductance while raising capacitance of the contact. This is found to significantly decrease the impedance of the power path. The designs shown in this application illustrate alternate ways of executing mechanical geometries to work in specific applications, however, slight obvious variations to these geometries can be done to accommodate other planar power interconnect architectures The following are definitions of terms that will be used in this description: VR=Voltage Regulator; VRD=Voltage Regulator Down, i.e., a voltage regulator that is soldered to a motherboard; VRM=Voltage Regulator Module; ZVR=Z-axis Voltage Regulator; NZVR=Negative Z-axis Voltage Regulator; and DZVR=Dual Z-axis Voltage Regulator.

It is therefore an object of the present invention to provide an improved low impedance, high power delivery contact for use with processors and semiconductor devices.

Another object of the present invention is to provide a power contact having multiple contact beams and which also has multiple current paths.

Still another object of the present invention is to provide a power contact that utilizes mutual coupling to reduce the overall inductance and resistance of the contact.

Yet a further object of the present invention is to provide a beam terminal for use in transmitting power between a circuit board and a processor in which the beam terminal includes two interengaging members, which cooperatively define four (4) current paths therein for the transmittal of power, and which paths assist on defining a low self-inductance and resistance current path through the beam terminal.

Still yet another object of the present invention is to provide a power contact for use in Z-axis (vertical) applications for connecting processors to circuit boards, the power contact having a plurality of current paths defined therein and reliable contact beams formed therewith.

The present invention provides these and other objects by way of its structure, which is briefly described below and is described in greater detail in the detailed description and drawings to follow.

In one aspect of the present invention, an improved power contact is provided by utilizing a box-type structure formed form the mating together of two interengaging U-shaped channels. The channels have a web and two flanges extending from the web, in a spaced-apart fashion, to define a hollow, intervening space that extends lengthwise through the channel. A contact arm may be formed in the webs of the two channels, and the contact arms extend inwardly from their respective webs into the hollow, intervening space. The contact arms engage each other when the channels are engaged together in a fashion so that the webs are on opposing surfaces of the contact.

The contact arms preferably extend at angles in opposite directions, so that when the two channels are assembled together, the contact arm of one of the channels, typically the top channel, will slide along and contact the contact arm of the second, or bottom channels. In this manner, multiple points of contact are achieved, both by the inner contact arms and the sidewalls of the two channels.

In another embodiment, the power contact is also formed by engaging together two channel members together, but each of the channel members includes a contact arm formed in one of the sidewalls, while the other channel sidewall includes a flat, deflectable beam, upon which the contact arm of the other channel rests. The webs of these two channels are oriented so they serve as sides of the overall power contact, and one end of each of the webs is provided with a faceplate that is bet at an angle to the channel web. These faceplates are interposed between the channel contact arms and are contacted by thc contact arms when the processor is assembled onto the power contact. The contact between the contact arms and the faceplate provide additional current paths to the power contact.

The power contacts of the present invention may be mounted on circuit board stubs that project outwardly and the stubs may project into the hollow, intervening spaces of the channels and support them in an insulating manner, without shorting the contacts but while providing an internal ground plane therein.

These and other objects, features and advantages of the present invention will be clearly understood through a consideration of the following detailed description.

### BRIEF DESCRIPTION OF THE DRAWINGS

In the course of this detailed description, the reference will be frequently made to the attached drawings in which:

FIG. 1 is a perspective view of a prior art power connector;

FIG. 2 is an exploded perspective view of a pair of contact components that are constructed in accordance with the principles of the present invention and which are shown in the form of U-shaped channel members and which are further shown separated from each other;

FIG. 3 is a perspective view of the two contact components of FIG. 2 showing them in an assembled state with their interior contact arms touching each other;

FIG. 3A is the same view as FIG. 3, but illustrating the two contact components of FIG. 2 assembled in a fully deflected state that emulates the condition of providing an electrical contact path between two circuit boards;

FIG. 4 is a sectional view of the two contact components s of FIG. 3, taken along lines 4-4 thereof and illustrating the manner of internal contact between the two contact arms of the assembled contact components;

FIG. 4A is a sectional view of the contact components of FIG. 3A, taken along lines 4A-4A thereof and illustrating the contact arms of the contact components in their fully deflected state;

FIG. 5 is an exploded perspective view of an alternate embodiment of an improved contact assembly of the invention, showing the two channel members separated from each other;

FIG. 6 is a perspective view of the two channel members of FIG. 6 assembled together to form a contact assembly;

FIG. 7 is a sectional view of the contact assembly of FIG. 6, taken along lines 7-7 thereof;

FIG. 8 is a perspective view of another embodiment of a power contact constructed in accordance with the principles of the present invention in which two U-shaped channels members are engaged with each other along a horizontal axis, rather then the vertical axes shown in the two embodiments illustrated in the preceding Figures;

FIG. 9 is a sectional view of the contact assembly of FIG. 8, taken along lines 9-9 thereof;

FIG. 10 is a partially exploded view of the contact assembly of FIG. 8 show in alignment with an insulating support member;

FIG. 11 is the same view as FIG. 10, but illustrating four contact assemblies in place upon the four support arms of the support member; and,

FIG. 12 is a partial sectional view of FIG. 11, taken along lines 12-12 thereof.

### DETAILED DESCRIPTION OF THE PREFERRED EMBODIMENTS

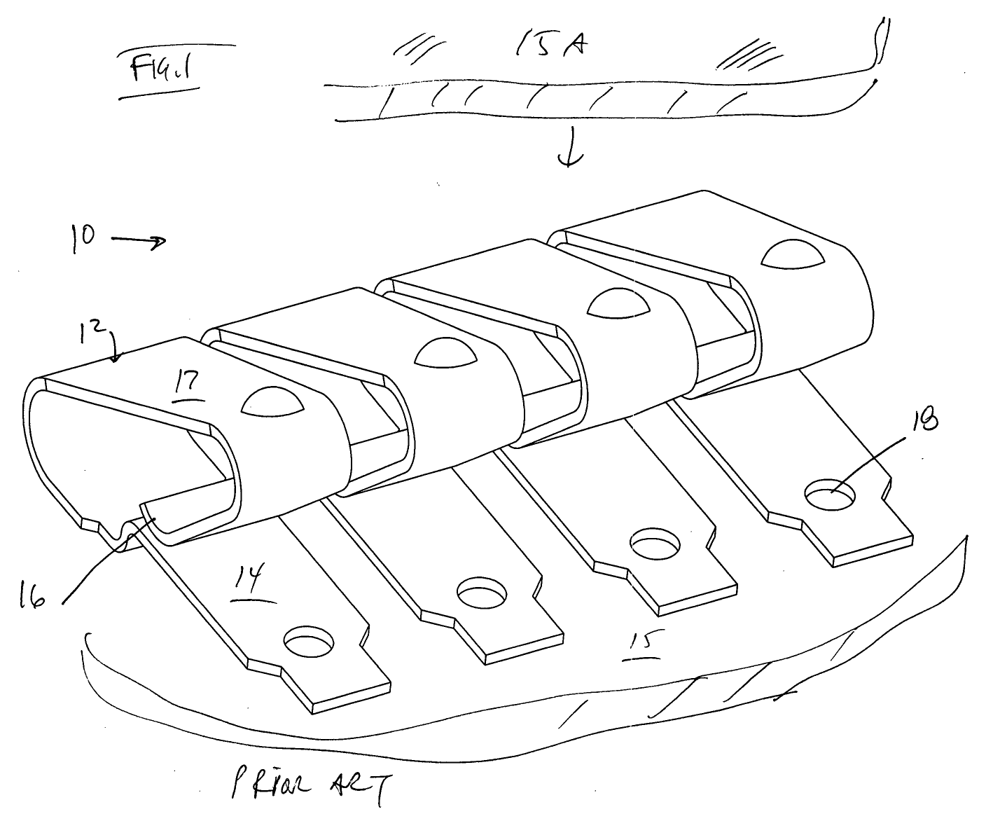

FIG. 1 illustrates a conventional power contact assembly 10 that is composed of a plurality of individual contact members 12, each such member 12 having a base portion 14 that is attached to a circuit board 15 such as by soldering, a free end 16 and a body portion 17 that interconnects the base and free ends 14, 16 together. Another circuit board 15A with circuitry thereupon is then pressed into contact with the contact assembly 10 and force is exerted upon the contact assembly 10 so that the free ends 16 contacts the base portion 14 and the body portion 17 will become generally parallel to the base and to the two circuit boards 15, 15A. The circuit board 15A may represent a circuit board as shown that supports a VRM or a ZVRM or it may represent a processor that is placed into contact with the contact assembly 10. The term ZVRM is used in the art to describe a voltage regulator module that is mounted above (or along the Z-axis) the motherboard 15.

The contacts 12 may be interconnected by a single base portion in some applications. This type of structure relies upon a single contact, or spring arm, namely the body portion 17 and free end portion 16. The contacts 12 shown have openings 18 that are formed in their base portions 14 and by which the contacts 12 may be attached to the circuit board 15 by way of soldering or fastening.

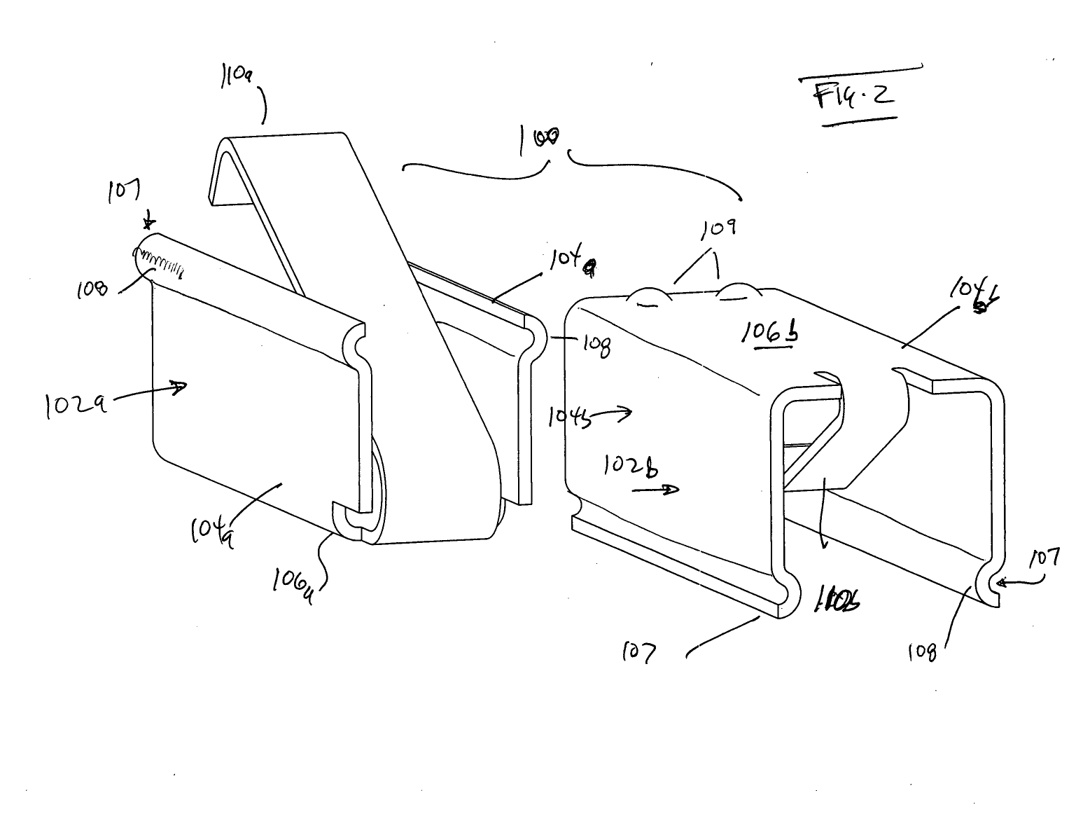

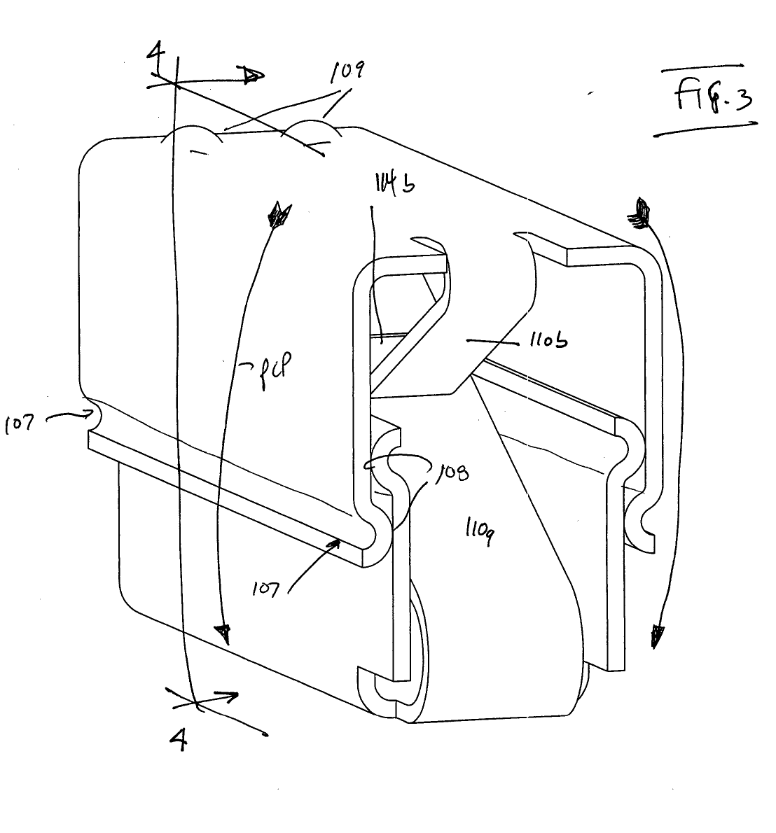

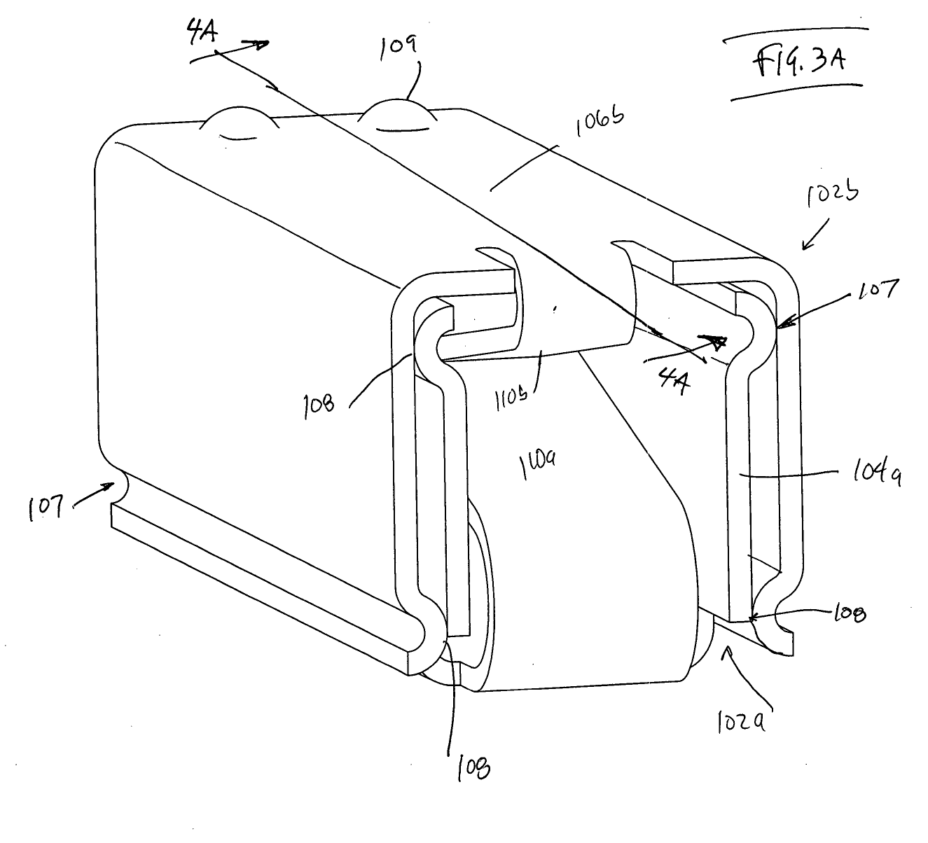

FIG. 2 illustrates a contact assembly 100 constructed in accordance with the principles of the present invention. The assembly can be seen to include a pair of conductive elements, that are formed as channel members 102a, 102b which have a U-shape or C-shape when viewed from an end. Each such channel member 102a, 102b includes two spaced-apart sidewalls, or flanges 104a, 104b that are spaced apart from each other by an interconnecting web member 106a, 106b. The ends 107 of the flanges 104a, 104b may have curled or curved configurations imparted to them as shown to provide a means for retaining the two channel members 102a, 102b in engagement with each other. The flange ends 107 may includes, as illustrated, curved surfaces 108 that provide contact points between the two channel members as shown best in FIG. 3.

The channel members 102a, 102b may also include as shown, projections 109 in the form of bumps that provide points by which the channel members may be soldered to an opposing circuit board, semiconductor or processor. The contacts are placed together in side-by-side order in the same fashion as that with the ordinary contacts of FIG. 1. This manner of placement presents a large metal surface area (in the form of the sidewalls of the flanges which act as plates in the electrical sense) oriented in a vertical direction and this tends reduce the inductance of the contacts and further reduces the mutual inductance of the system.

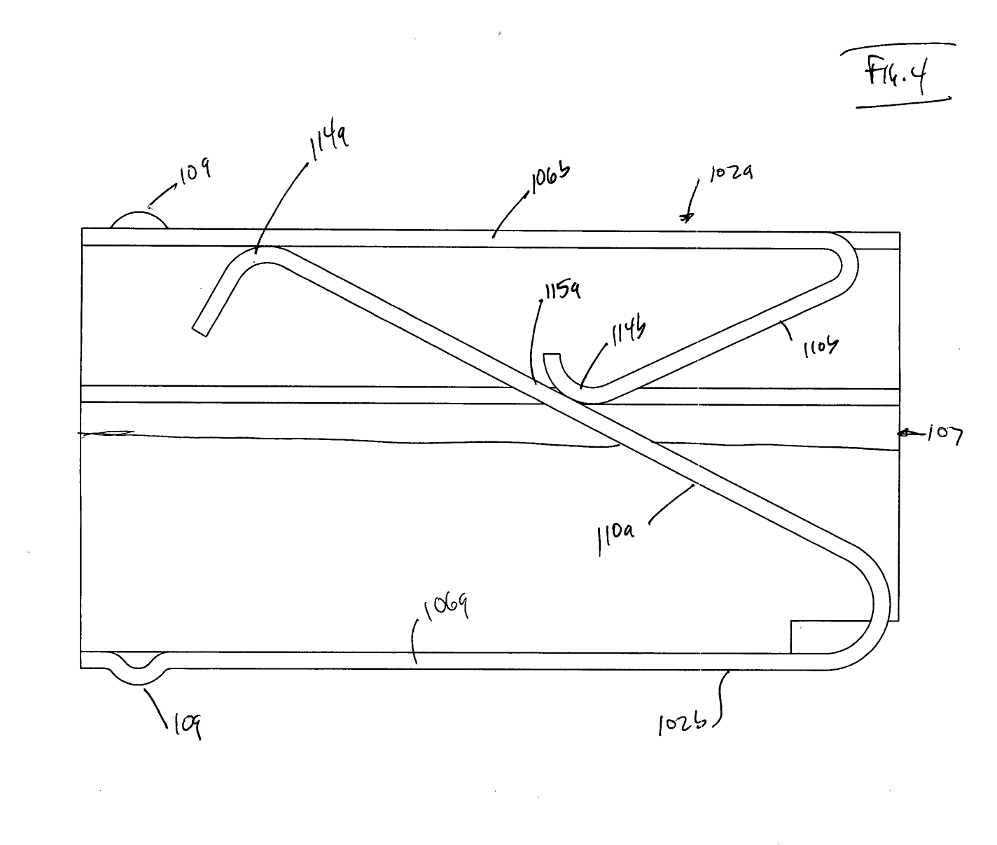

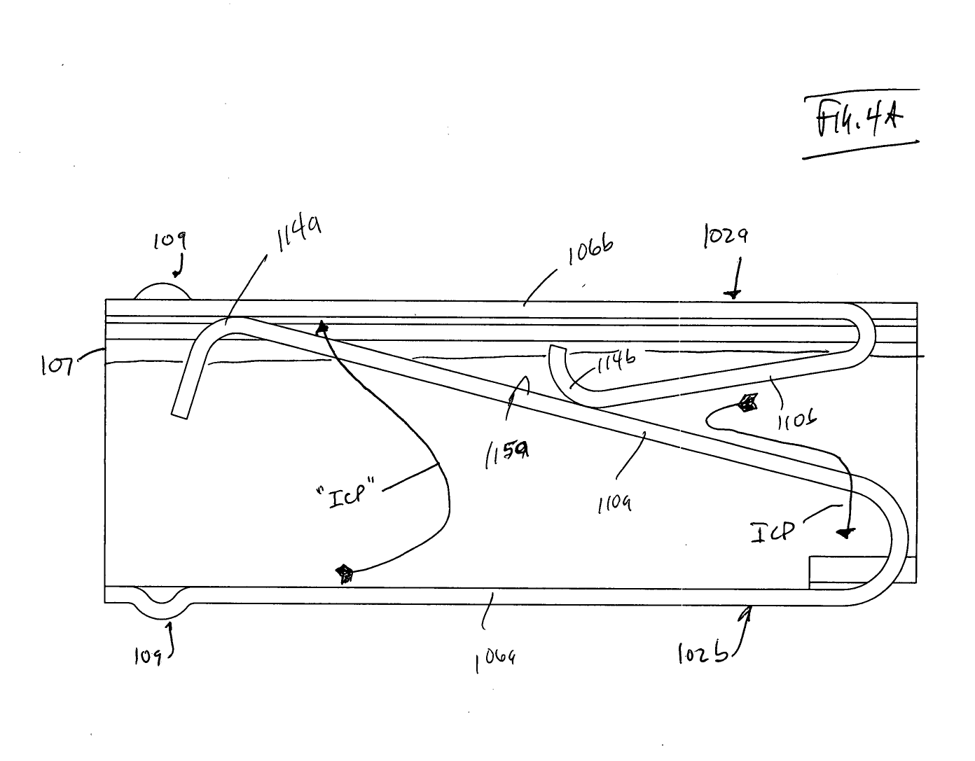

Each channel member 102a, b can be further seen to include a contact arm 110a, b that is formed from the channel member web and which is bent to some extent back upon the web to define a spring contact arm. These two contact arms 110a,b extend inwardly into their respect channels in different directions, as best shown in FIGS. 3 and 4 so that their free ends make contact with opposing surfaces of their respective opposing channel member. The contact between the two inner contact arms provides one current path, while the contact of the free ends of the flanges of the channel members on the outside surfaces thereof provides another current path, shown by the arrows “PCP” in FIG. 3.

As shown best in FIGS. 3 & 3A, the free ends 108 of the flange ends 107 nest within each other and make contact with the opposing channel member 102a, 102b. FIG. 4 shows the two channel members 102a, 102b fully engaged and deflected, such as when a ZVRM or a processor 15A is applied to the assembly and it is pressed downwardly. These curved free ends 108 extend slightly outwardly from the flanges 107 of the channel members 102a, 102b when the two channel members are interengaged as shown and as such, they preferably define a gap between the sidewalls of the flanges 107.

As illustrated best in FIG. 4, which is a sectional view that shows the mechanical interaction on the inner contact arms 110a, 10b. As shown, the free end 114a of the lower contact arm 110a extends upwardly into contact with the interior surface of the web 106b of upper channel member 102b, while the free end 114b of the upper channel member 102b extends downwardly through the channel and into contact with an opposing surface 115a (or body portion) of the contact arm 10a of the lower channel member 102b. FIG. 4A shows the two channel members 102a, 102b engaged together while under full deflection with each contact arm contacting a different portion of the contact assembly. In this manner, multiple current carrying paths are created by the contact, and as shown there are current paths PCP that occur along the exterior surfaces of the channel members, as well as inner current paths that are identified by the arrows “ICP” in FIG. 4A.

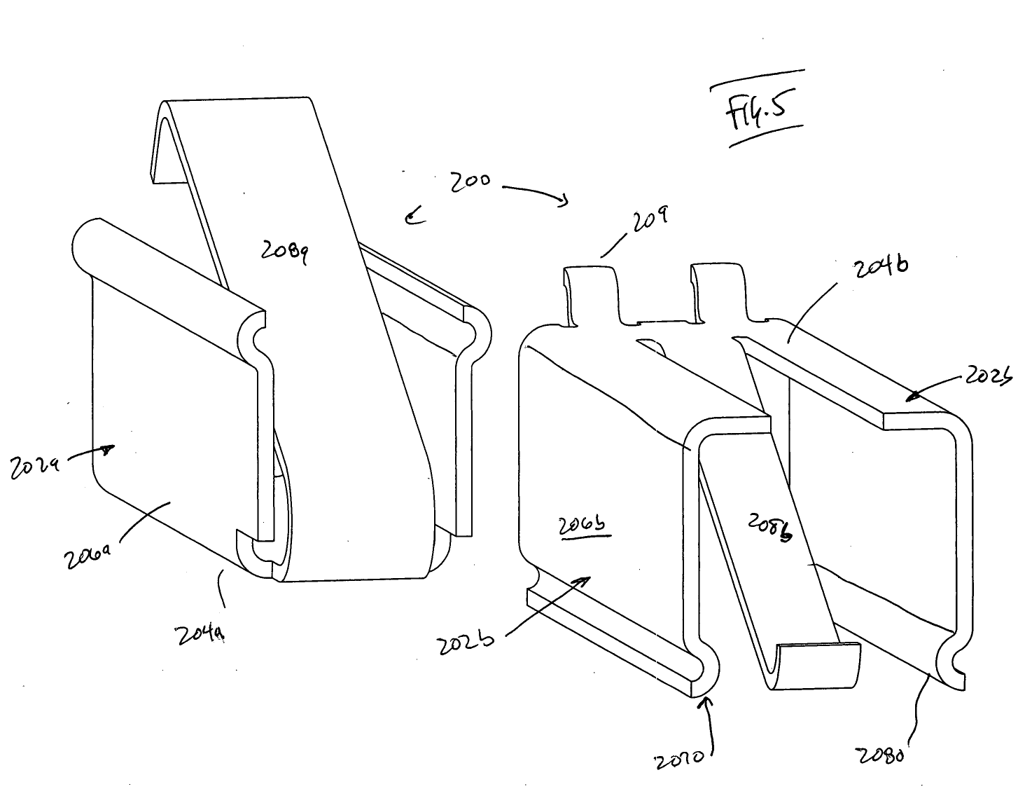

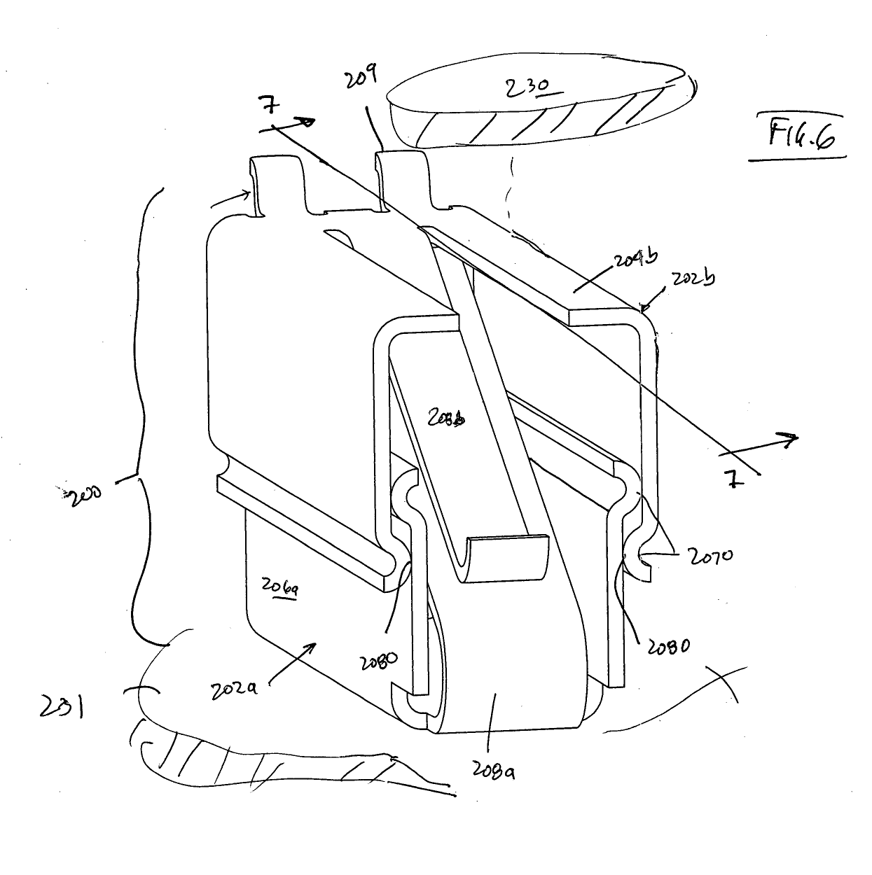

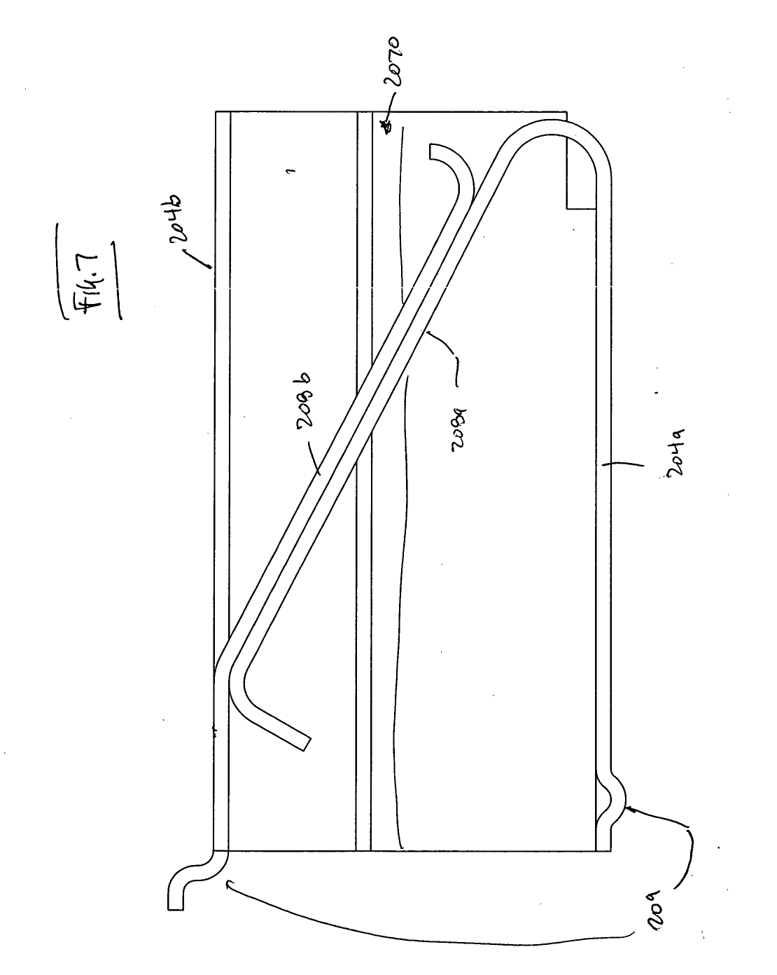

FIGS. 5-7 illustrate another embodiment 200 of a contact constructed in accordance with the principles of the present invention. This embodiment also uses a pair of channel members 202a, 202b that engage each other in the previous manner illustrated. These channel members include respective contact arms 208a 208b that are integrally formed therewith and preferably formed as part of the webs 204a, 204b of the channel members 202a, 202b. These contact arms 208a, 208b also extend inwardly at opposite directions and preferably at an angle to each other such as that shown in FIGS. 5-7. The contact arms 208a, 208b are deflectable and tend to slide against each other when the two channel members 202a, 202b components are engaged together as shown best in FIG. 7. In such an embodiment, multiple current paths are defined. As in the previous embodiment, two such current paths lie along the exterior sides of the channel members 202a, 202b, while the two contact arms 208a, 208b define a third current path which lies within the flanges of the channel members 202a, 202b. The ends 2070 of the channel flanges terminate in free curved ends 2080 which slide upon and contact the flange sidewalls 206a, 206b. Solder tabs 209 may be used to connect the channel members to circuit boards 230, 231.

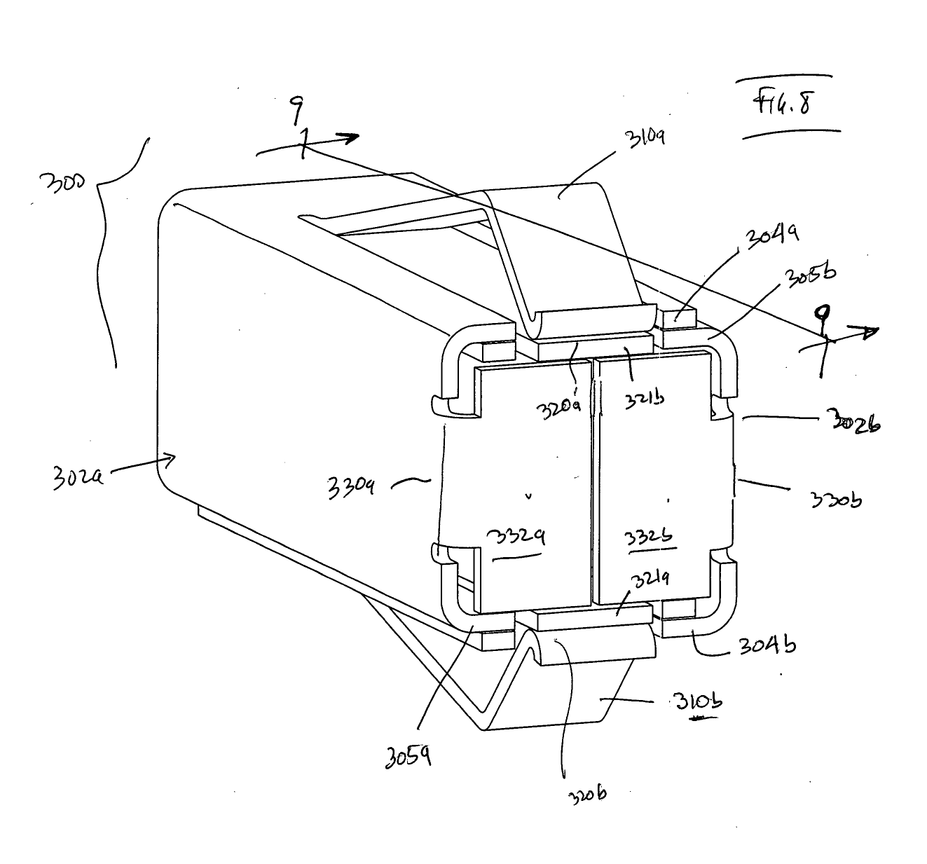

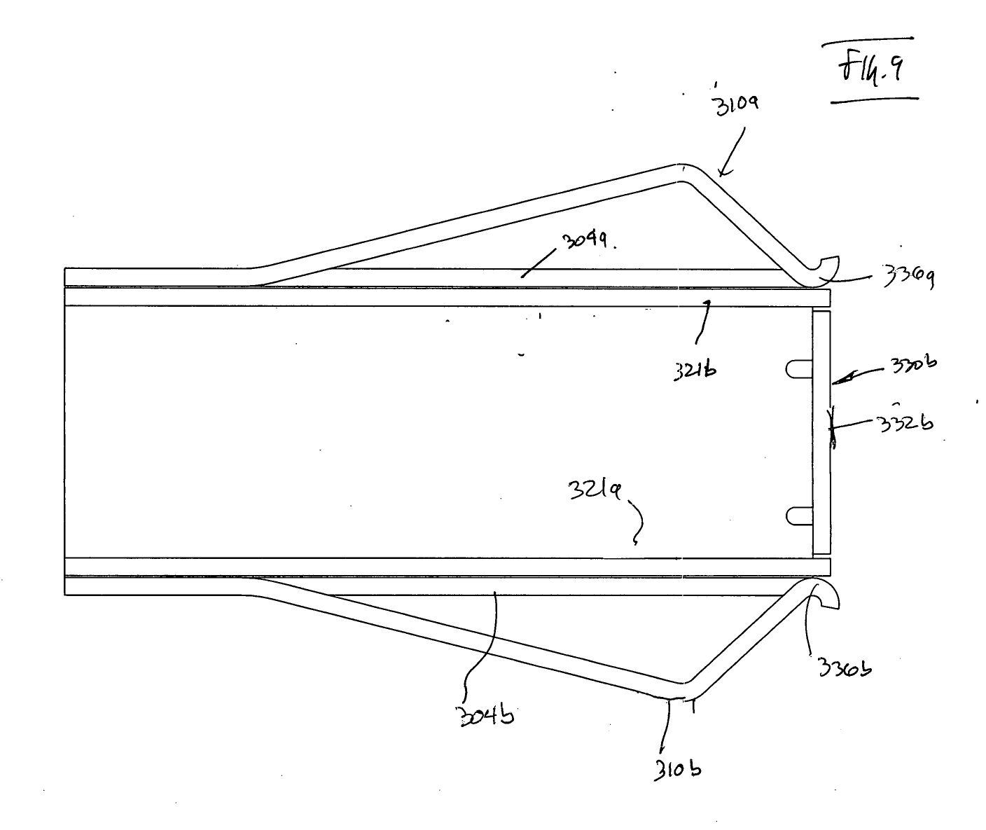

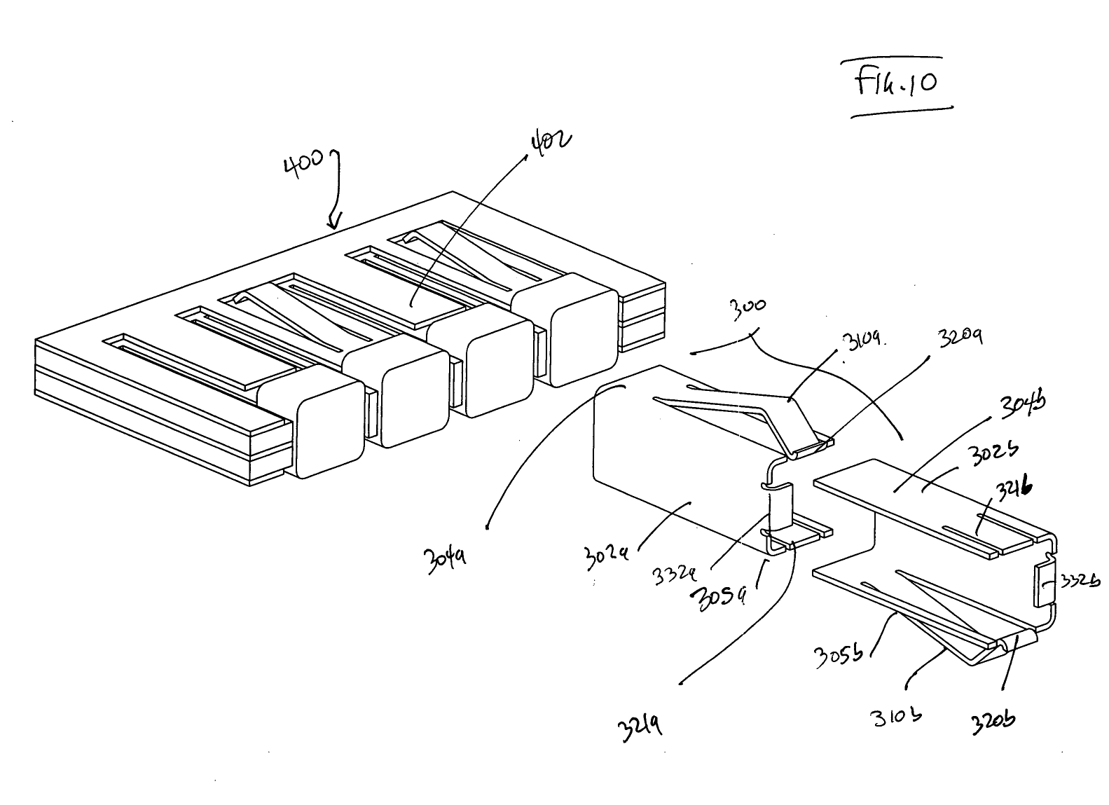

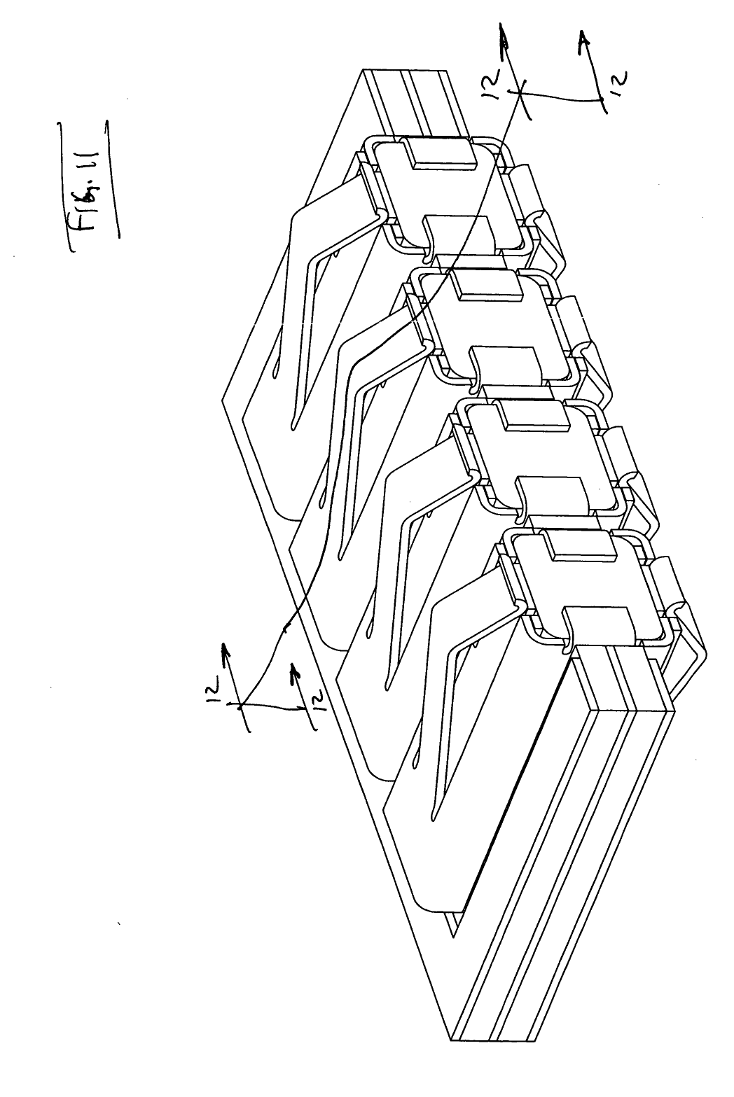

FIGS. 8-12 illustrate yet another embodiment 300 of a power contact constructed in accordance with the principles of the present invention in which the contact uses two channel-shaped components 302a 302b which are aligned with each other and engaged with each other along a horizontal direction or axis in contrast to the vertical alignment and engagement shown earlier in FIGS. 1-7. The channel components 302a 302b have contact portions preferably integrally formed therewith in one of their sidewalls, or flanges 304a and 305b. These contact portions are shown as contact or spring arms 310a, 310b that are preferably bent outwardly at an angle and have free ends 320a 320b that bear against opposing plates 321a, 321b that are formed in the other of the two flanges or sidewalls, 305a, 305b. Also, as shown in the drawings, ends 330a, 330b may be bent inwardly into the interior space of the channel members to define conductive face plates 332a, 332b that are spaced apart from the plates 321a, 321b. Pressure on the contact arms 310a, 310b will cause them to slide along the plates 321b, 321a and press them against the face plates, thereby completing another current path of the contact assembly 300. The free ends 320a, 320b of the contact arms 310a, 310b are preferably curled or curved to facilitate their movement upon the plates 321a, 321b.

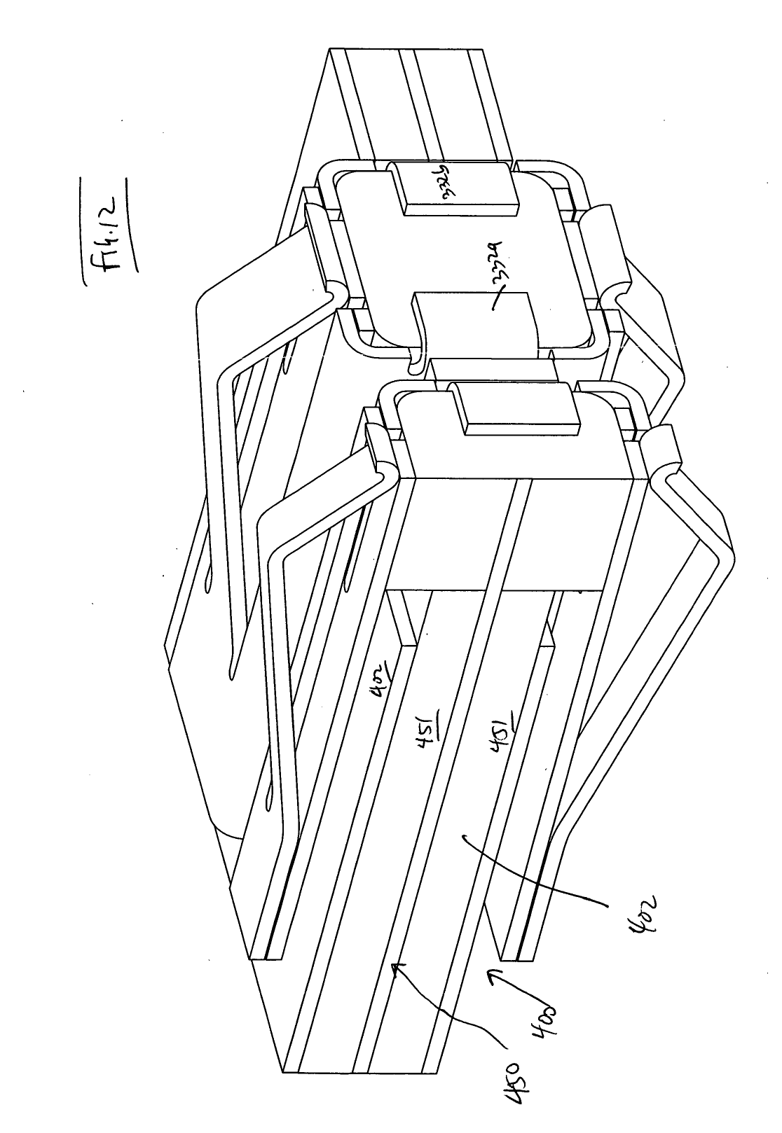

This type of construction permits the contact assembly components to be mounted on a support structure 400 that has a series of individual support arms 402 that are cantilevered therefrom. This structure may be used in an interposer application and in such an application, as best shown in FIG. 12, a conductive ground plane 450 may be interposed within the insulative portions 451 of the circuit board 400. Other conductive layers may be use don'the circuit board.

In the first two embodiments, the connector components may be attached to their respective circuit boards and then snapped together into engagement.

Testing has shown that this box contact style design, with its plurality of engaging walls and multiple current paths lowers the inductance of the contact and raises the capacitance. This results in a significant decrease in the power path impedance.

While the preferred embodiment of the invention have been shown and described, it will be apparent to those skilled in the art that changes and modifications may be made therein without departing from the spirit of the invention, the scope of which is defined by the appended claims.

1. A low inductance power contact for use in providing power to a processor between circuits on two circuit boards, comprising, a general box-like structure from two interengaging channel-shaped conductive components, each of the components having a web interconnecting two spaced-apart flanges, the flanges being spaced apart from each other at different spacings so that one component is received within the channel of the other component, each of the components further having a contact portion formed as part of the web and bent at an angle thereto, the contact portions extending into said channels so that, when said two components are assembled together, said contact portions engage each other within said channels.
